(19) United States
(12) Patent Application Publication
(10) Pub. No.: US 2016/0188453 A1
(43) Pub. Date: Jun. 30, 2016

(54) MEMORY POOL MANAGEMENT METHOD FOR SHARING MEMORY POOL AMONG DIFFERENT COMPUTING UNITS AND RELATED MACHINE READABLE MEDIUM AND MEMORY POOL MANAGEMENT APPARATUS

(71) Applicant: MEDIATEK INC., Hsin-Chu, (TW)

(72) Inventors: Yu-Cheng Chu, Hsinchu City (TW); Shen-Kai Chang, Hsinchu City (TW); Yong-Ming Chen, Talchung City (TW); Chi-Cheng Ju, Hsinchu City (TW)

(73) Assignee: MEDIATEK INC., Hsin-Chu (TW)

(21) Appl. No.: 14/902,596

(22) PCT Filed: May 28, 2015
(86) PCT No.: PCT/CN2015/080092

§ 371 Date: Jan. 4, 2016

Related U.S. Application Data
(60) Provisional application No. 62/003,611, filed on May 28, 2014.

(51) Int. Cl. G06F 12/02

(52) U.S. Cl. CPC G06F 12/023; G06F 2212/1044

(57) ABSTRACT

A memory pool management method includes: allocating a plurality of memory pools in a memory device according to information about a plurality of computing units, wherein the computing units are independently executed on a same processor; and assigning one of the memory pools to one of the computing units, wherein at least one of the memory pools is shared among different computing units of the computing units.

### CROSS REFERENCE TO RELATED APPLICATIONS

This application claims the benefit of U.S. provisional application No. 62/003,611, filed on May 28, 2014 and incorporated herein by reference.

### TECHNICAL FIELD

The disclosed embodiments of the present invention relate to memory pool management, and more particularly, to a memory pool management method for sharing one memory pool among different computing units and related machine readable medium and memory pool management apparatus.

### BACKGROUND

To accomplish one process, multiple computing units (or threads) may be independently executed on the same processor such as a graphics processing unit (GPU). A memory pool management function is generally used to manage memory pools allocated in a memory device accessed by the processor. In a conventional memory pool management design employed by the GPU, each computing unit has its own memory pool. In other words, there is a one-to-one mapping between computing units and memory pools. When the number of computing units for one process is large, the number of memory pools allocated in the memory device is large. As a result, the memory device used by the GPU is required to have a large memory size to meet the requirement of the computing units, which increases the production cost inevitably.

### SUMMARY

In accordance with exemplary embodiments of the present invention, a memory pool management method for sharing one memory pool among different computing units and related machine readable medium and memory pool management apparatus are proposed to solve the above-mentioned problem.

According to a first aspect of the present invention, an exemplary memory pool management method is disclosed. The exemplary memory pool management method includes: allocating a plurality of memory pools in a memory device according to information about a plurality of computing units, wherein the computing units are independently executed on a same processor; and assigning one of the memory pools to one of the computing units, wherein at least one of the memory pools is shared among different computing units of the computing units.

According to a second aspect of the present invention, an exemplary non-transitory machine readable medium is disclosed. The exemplary non-transitory machine readable medium has a program code stored therein. When executed by a processor, the program code instructs the processor to perform following steps: allocating a plurality of memory pools in a memory device according to information about a plurality of computing units, wherein the computing units are independently executed on the processor; and assigning one of the memory pools to one of the computing units, wherein at least one of the memory pools is shared among different computing units of the computing units.

According to a third aspect of the present invention, an exemplary memory pool management apparatus is disclosed. The exemplary memory pool management apparatus includes an allocating circuit and a dispatching circuit. The allocating circuit is arranged to allocate a plurality of memory pools in a memory device according to information about a plurality of computing units, wherein the computing units are independently executed on a same processor. The dispatching circuit is arranged to assign one of the memory pools to one of the computing units, wherein at least one of the memory pools is shared among different computing units of the computing units.

These and other objectives of the present invention will no doubt become obvious to those of ordinary skill in the art after reading the following detailed description of the preferred embodiment that is illustrated in the various figures and drawings.

### BRIEF DESCRIPTION OF DRAWINGS

FIG. 1 is a diagram illustrating a computing system according to an embodiment of the present invention.

FIG. 2 is a flowchart illustrating a first memory pool management according to an embodiment of the present invention.

FIG. 3 is a diagram illustrating an example of memory pools allocated in a memory device.

FIG. 4 is a flowchart illustrating a method for finding a most frequently used memory pool according to an embodiment of the present invention.

FIG. 5 is a diagram illustrating an example of memory pool management under a condition that the number of memory pools is not smaller than the number of computing units.

FIG. 6 is a flowchart illustrating a second memory pool management according to an embodiment of the present invention.

FIG. 7 is a diagram illustrating an example of memory pool management under a condition that the number of memory pools is smaller than the number of computing units.

FIG. 8 is a diagram illustrating another computing system according to an embodiment of the present invention.

### DETAILED DESCRIPTION

Certain terms are used throughout the description and following claims to refer to particular components. As one skilled in the art will appreciate, manufacturers may refer to a component by different names. This document does not intend to distinguish between components that differ in name but not function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

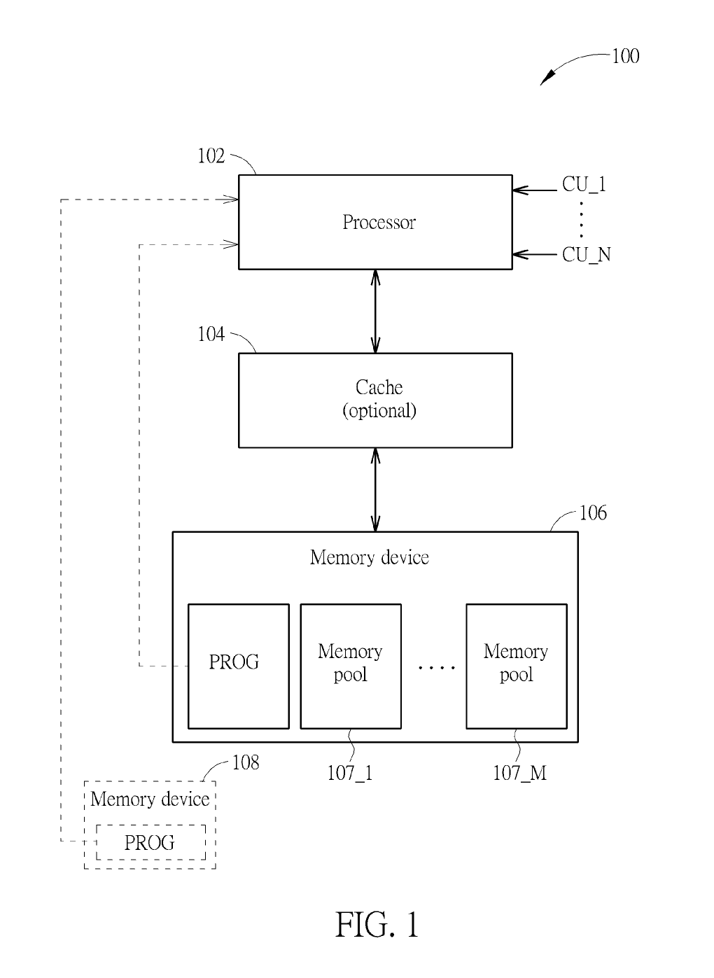

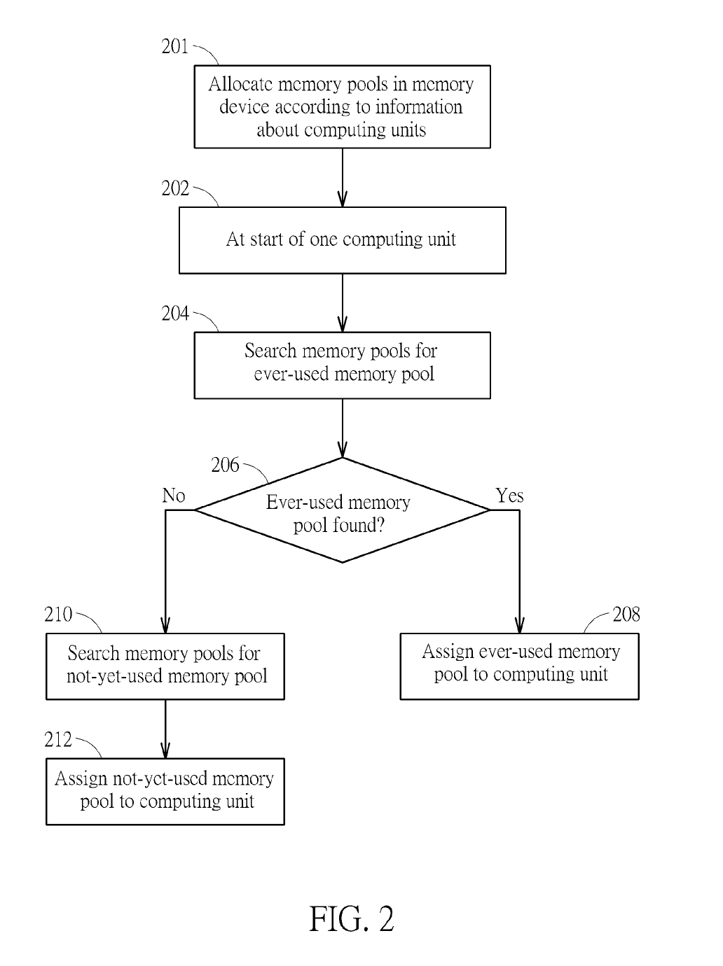

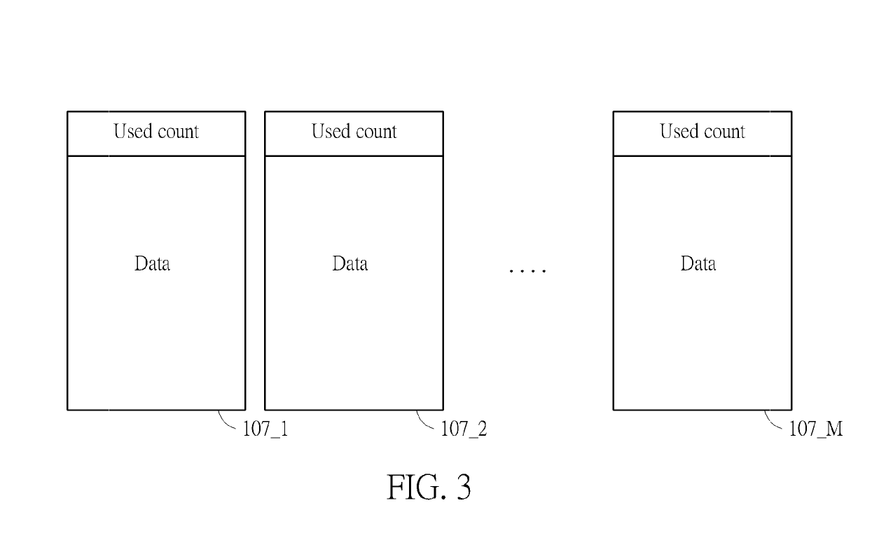

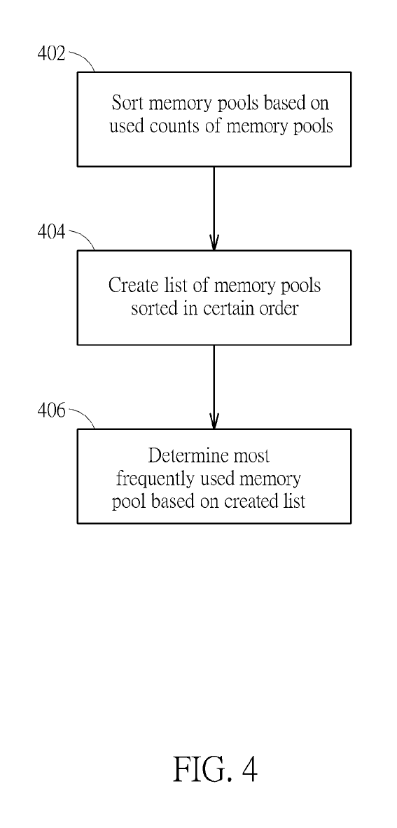

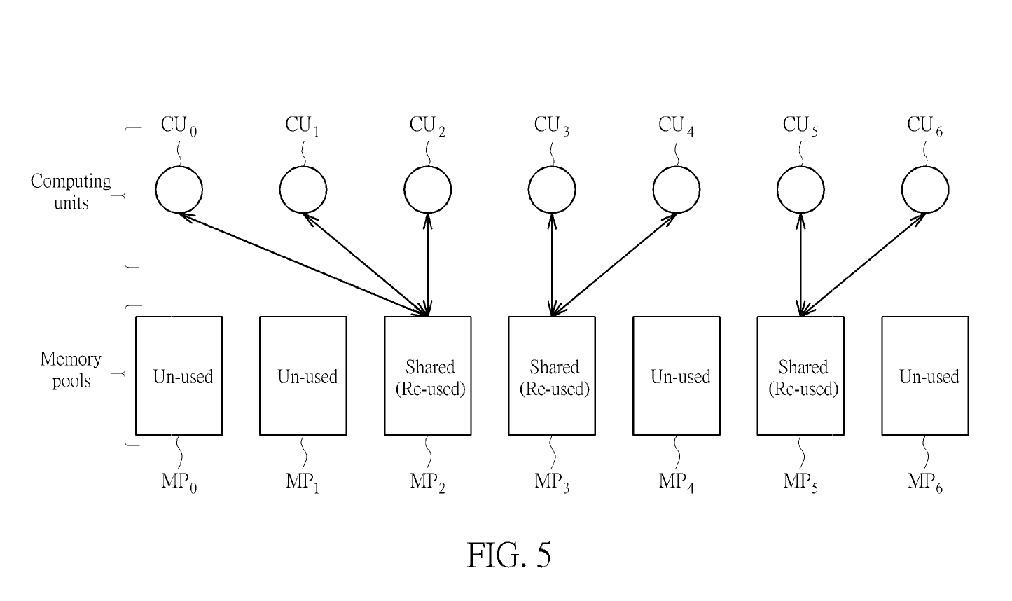

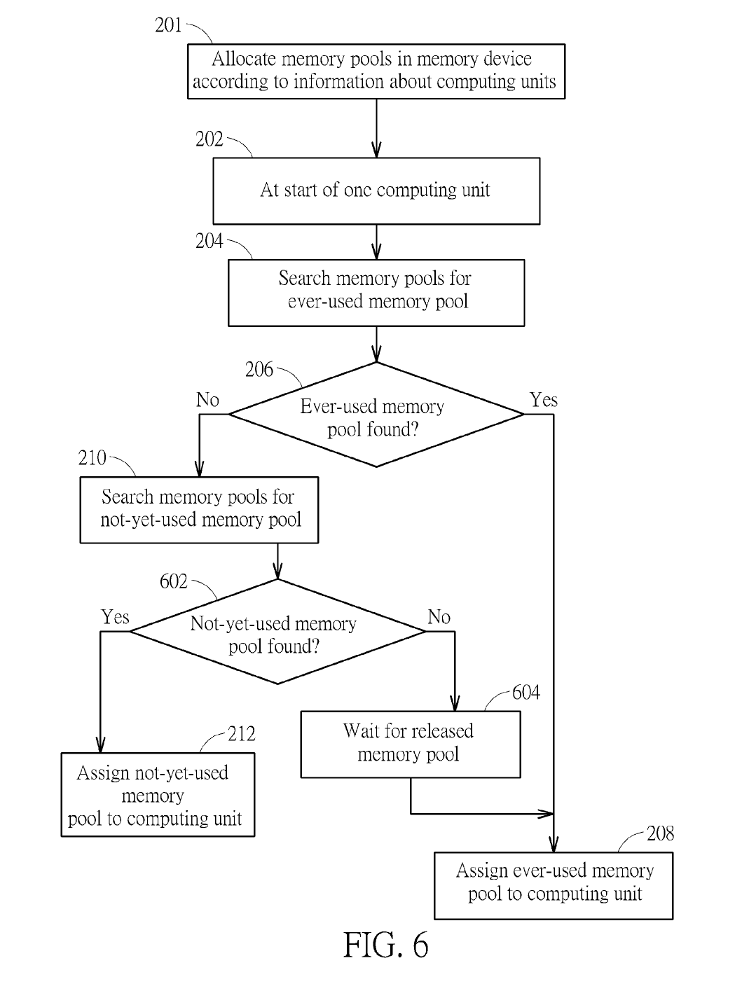

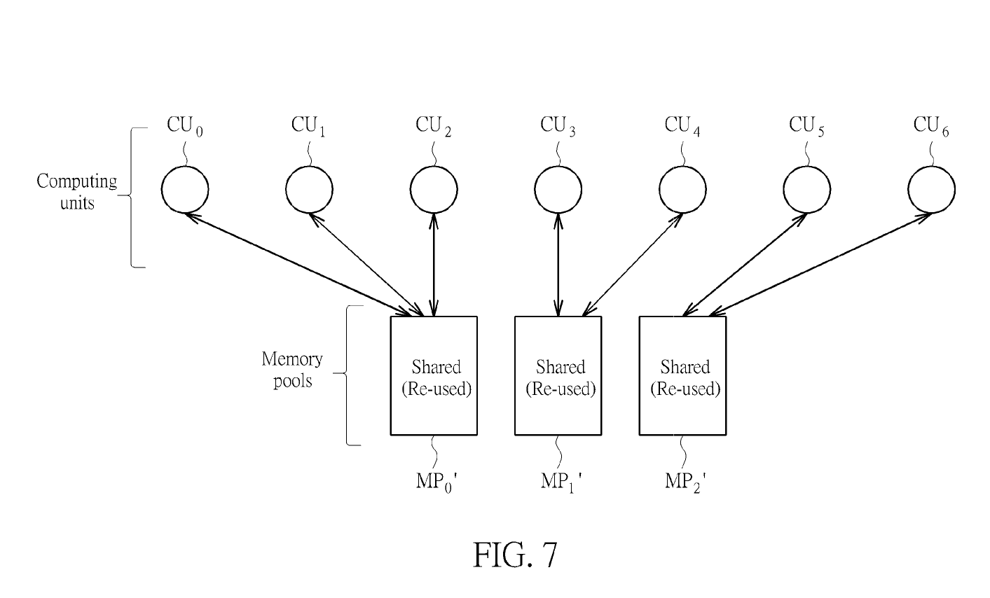

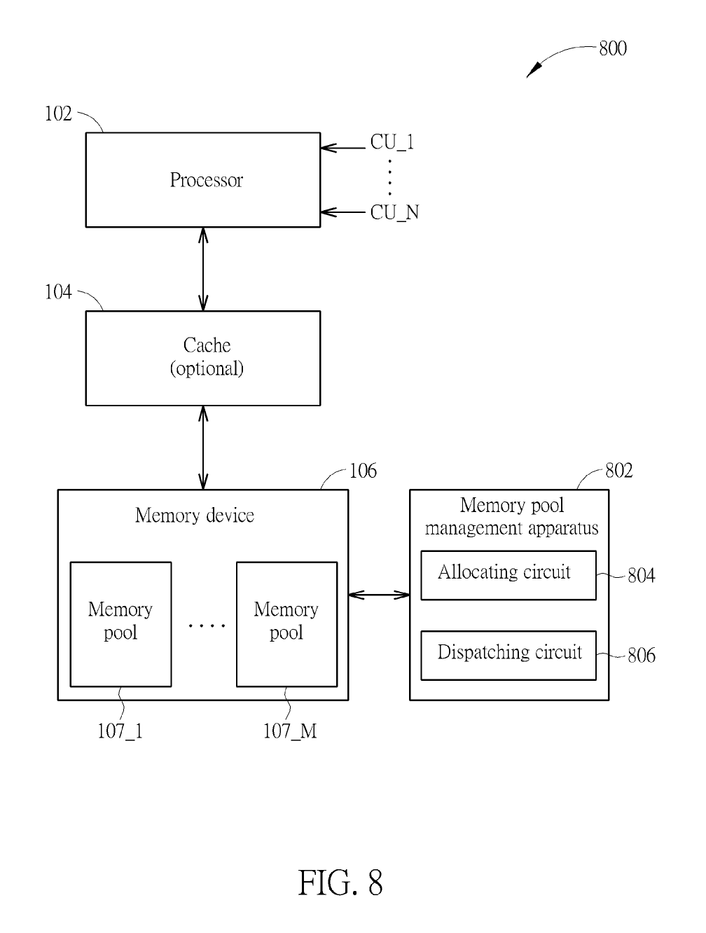

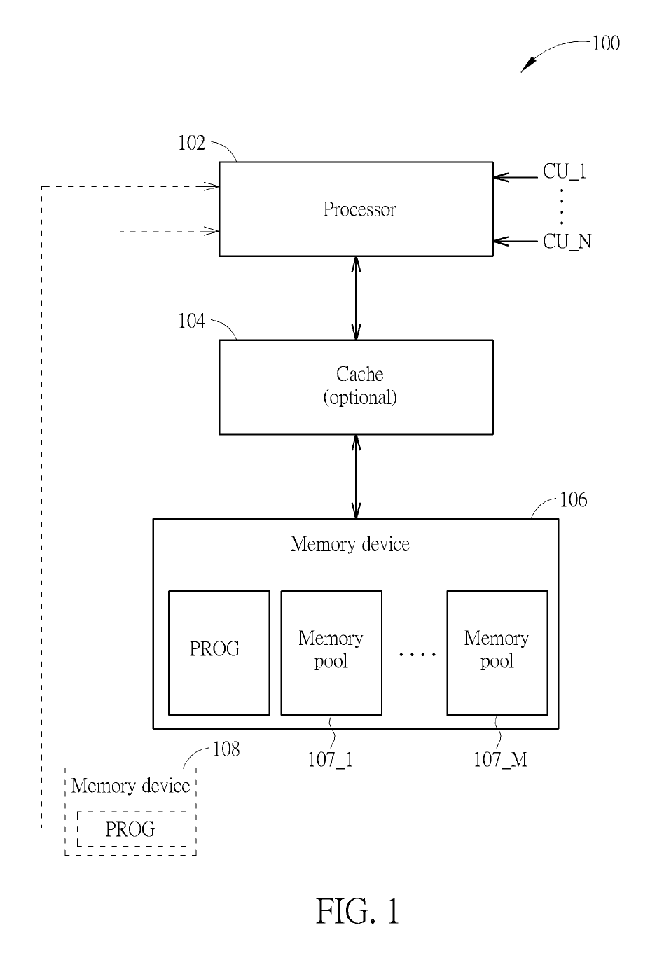

FIG. 1 is a diagram illustrating a computing system according to an embodiment of the present invention. The computing system 100 includes a processor 102, a cache 104, and a memory device 106, where the cache 104 is coupled between the processor 102 and the memory device 106. The cache 104 may be an optional component, depending upon the actual design considerations. For example, the cache 104 may be omitted in an alternative computing system design. By way of example, but not limitation, the computing system 100 may be a graphics processing system, the processor 102 may be GPU, central processing unit (CPU) or any other type of processor (e.g., digital signal processor (DSP)). The memory device 106 is a non-transitory machine readable medium, and may be a dynamic random access memory (DRAM), a static random access memory (SRAM) or any other type of memory device which may be utilized to save data (e.g., local variables). In this embodiment, the memory device 106 has a program code PROG stored therein. When loaded and executed by the processor 102, the program code PROG instructs the processor 102 to perform a memory pool management function. Specifically, the program code PROG is memory pool management software configured to perform the proposed memory pool management with memory pool sharing/reusing. In this embodiment, the memory pool management (i.e., the program code PROG running on the processor 102) allocates a plurality of memory pools 107_1-107_M in the memory device 106 according to information about a plurality of computing units CU_1-CU_N of a process, where the computing units CU_1-CU_N are independently executed on the same processor 102; and further assigns one of the memory pools 107_1-107_M to one of the computing units CU_1-CU_M, where at least one of the memory pools 107_1-107_M is shared among different computing units of the computing units CU_1-CU_N. The computing units CU_1-CU_N may be defined by a programming language. For example, each of the computing units CU_1-CU_N may be a work item or a work group as defined in OpenCL (Open Computing Language). For another example, each of the computing units CU_1-CU_N may be a pixel as defined in OpenGL (Open Graphics Library). However, this is for illustrative purposes only, and is not meant to be a limitation of the present invention.

In this embodiment, the processor 102 may load the program code PROG from the memory device 106 through the cache 104. However, this is for illustrative purposes only. For example, the processor 102 may be configured to load the program code PROG from the memory device 106 directly. It should be noted that using the same memory device 106 to store the program code PROG and allocate the memory pools 107_1-107_M is merely one feasible implementation. Alternatively, the memory pools 107_1-107_M may be allocated in the memory device 106, and the program code PROG may be stored in another memory device 108. The memory device 108 is a non-transitory machine readable medium, and may be a DRAM, an SRAM, or any other type of memory device which may be utilized to save program data. In addition, the processor 102 may be configured to load the program code PROG from the memory device 108 directly.

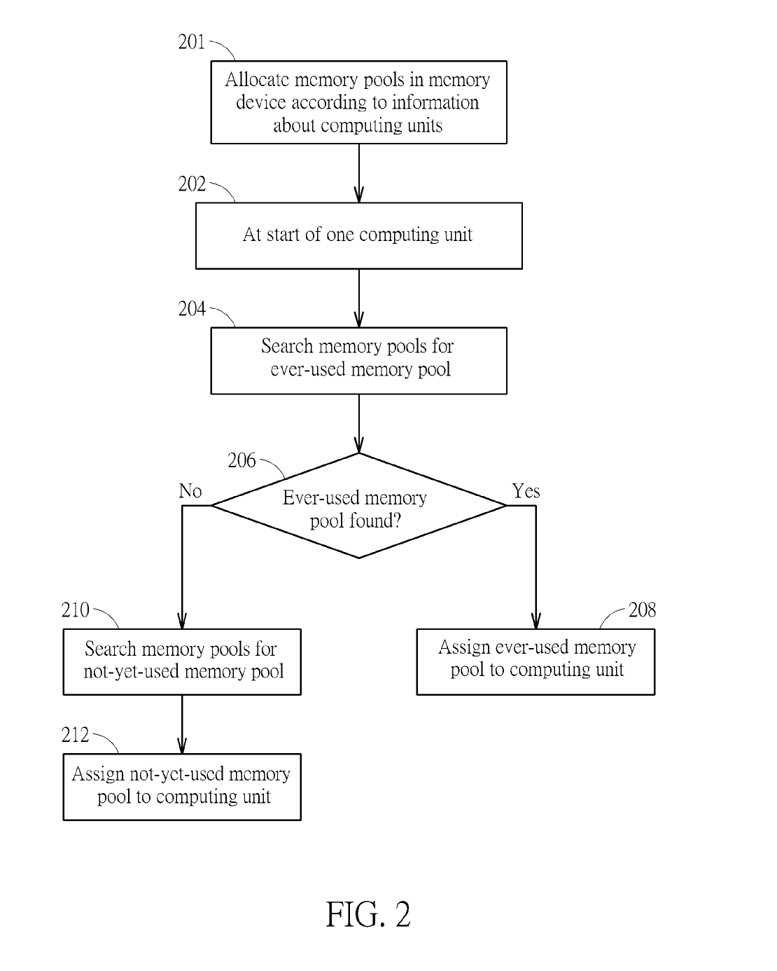

The proposed memory pool management rule may be related to the number of memory pools, the number of computing units, and availability and utilization rate of ever-used memory pool(s). In a case where the number of the memory pools 107_1-107_M is not smaller than the number of the computing units CU_1-CU_N (i.e., M≧N), the proposed memory pool management may be configured to assign an ever-used memory pool or a not-yet-used memory pool to a computing unit. FIG. 2 is a flowchart illustrating a first memory pool management according to an embodiment of the present invention. Provided that the result is substantially the same, the steps are not required to be executed in the exact order shown in FIG. 2. The memory pool management method may be performed by the program code PROG loaded and executed by the processor 102, and may be briefly summarized as below.

Step 201: Allocate a plurality of memory pools in a memory device according to information about a plurality of computing units, where the computing units are independently executed on a same processor (e.g., GPU).

Step 202: At the start of one of the computing units.

Step 204: Search memory pools for an ever-used memory pool.

Step 206: Is the ever-used memory pool found in the memory pools? If yes, go to step 208; otherwise, go to step 210.

Step 208: Assign the ever-used memory pool found in the memory pools to the computing unit.

Step 210: Search the memory pools for a not-yet-used memory pool.

Step 212: Assign the not-yet-used memory pool found in the memory pools to the computing unit.

To accomplish one process, multiple computing units (e.g., threads) CU_1-CU_N may be independently executed on the same processor 102. Hence, before any of the computing units CU_1-CU_N is executed by the processor 102, the memory pool management function (i.e., program code PROG running on processor 102) allocates multiple memory pools 107_1-107_M in the memory device 106, where M≧N (Step 201). In some other embodiments, the memory pools 107_1-107_M may be allocated after the computing units CU_1-CU_N to be executed by the processor 102 are determined. In other words, the memory pools 107_1-107_M may be allocated in response to the determined computing units CU_1-CU_N. The memory pool management function supports sharing/reusing one memory pool. Initially, all of the memory pools 107_1-107_M allocated in the memory device 106 are not-yet-used memory pools. When a not-yet-used memory pool is selected and assigned to a first computing unit, the not-yet-used memory pool becomes an in-used memory pool during execution of the first computing unit. After the execution of the first computing unit is completed, the in-used memory pool is released and then becomes an ever-used memory pool with a used count set by one updated value (e.g., 1). When the ever-used memory pool is selected and assigned to a second computing unit that is executed later than the first computing unit, the ever-used memory pool becomes an in-used memory pool during execution of the second computing unit. After the execution of the second computing unit is completed, the in-used memory pool is released and becomes the ever-used memory pool with the used count set by another updated value (e.g., 2).

When the processor 102 starts executing one of the computing units CU_1-CU_N, a memory pool query from the computing unit is received by the memory pool management function (Step 202). Alternatively, when the processor 102 starts executing one of the computing units CU_1-CU_N, the flow may proceed with the next step (Step 204) directly. When any of the computing units CU_1-CU_N is started for execution, the flow enters step 202 and finds a memory pool for the computing unit through following steps (e.g., Steps 204, 206, 210 and 212; or Steps 204, 206 and 208).

In step 204, the memory pool management function searches memory pools 107_1-107_M for an ever-used memory pool (i.e., a memory pool that has been used by a different computing unit executed earlier and is not in use now). The benefits of selecting an ever-used memory pool include reducing the cache write miss rate of the cache 104 as well as the bandwidth usage between the cache 104 and the memory device 106. Though the computing units CU_1-CU_N are executed independently on the same processor 102, different computing units may share the same memory pool and access data at the same memory address in the memory pool. Hence, when a later-executed computing unit wants to store a write data into a memory address that was read/written by an earlier-executed computing unit, a cache hit event for the write data occurs, and the write data is directly written into the cache 104 without further memory access of the memory device 106.

When the ever-used memory pool can be found in the memory pools 107_1-107_M, the memory pool management function assigns the ever-used memory pool to the computing unit (steps 206 and 208). In one exemplary embodiment, the ever-used memory pool selected by the memory pool management function may be a most frequently used memory pool among the memory pools 107_1-107_4 (particularly, a most frequently used memory pool among ever-used memory pools). FIG. 3 is a diagram illustrating an example of the memory pools 107_1-107_M allocated in the memory device 106. Each of the memory pools 107_1-107_M has a first section arranged to store a used count and a second section arranged to store data (e.g., local variables of a computing unit). The used count of a memory pool records the number of times the memory pool has been used by one computing unit. Hence, the memory pool management function can check the used counts of all memory pools 107_1-107_M to determine which of the memory pools 107_1-107_M is used most frequently. In some other embodiments, the used counts of the memory pools 107_1-107_M may be stored in some other portions in the memory device 106 or any other memory device, which should not be limited in this disclosure.

For example, the memory pool management function may find a most frequently used memory pool from the memory pools 107_1-107_M based on the following pseudo code.

```
C_MP = MP_1
for (i=2; i<M+1; i++){
  if(C_MP.used_cnt < MP_i.used_cnt)
  C_MP = MP_i;
}
```

In above pseudo code, C_MP represents a most frequently used memory pool, and is initially set by the first memory pool (e.g., MP_1=107_1). When the next memory pool (e.g., MP_i=107_2) has a corresponding used count MP_i.used_cnt larger than the used count C_MP.used_cnt of the currently selected most frequently used memory pool, C_MP is updated by MP_i. However, when the next memory pool (e.g., MP_i=107_2) has the corresponding used count MP_i.used_cnt not larger than the used count C_MP.used_cnt of the currently selected most frequently used memory pool, C_MP remains unchanged. After used counts of the memory pools 107_2-107_M have been checked, the most frequently used memory pool C_MP is found.

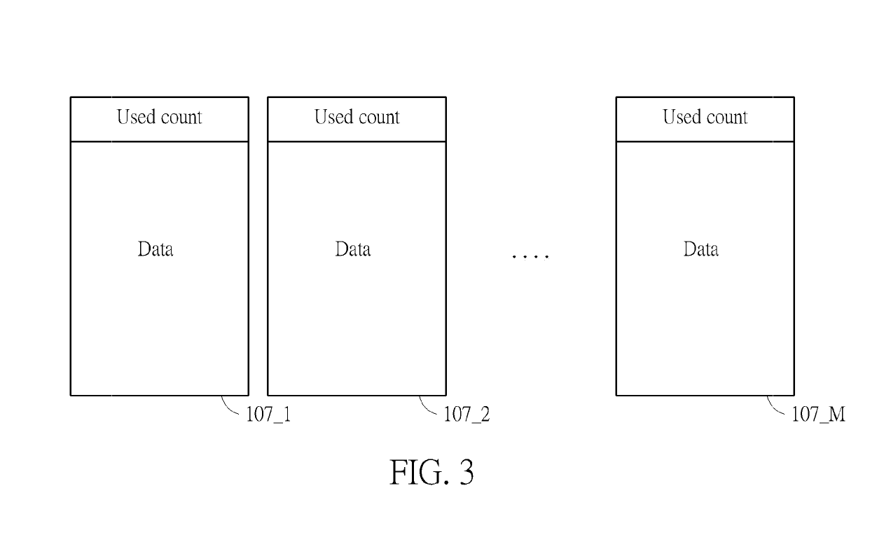

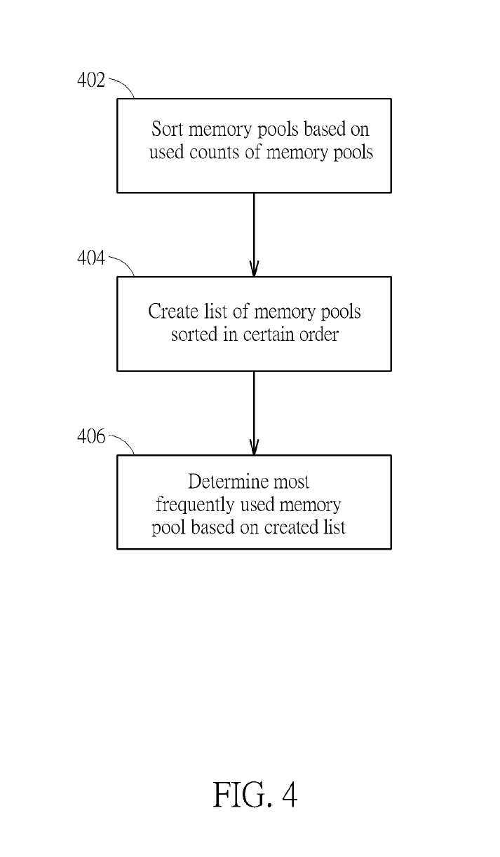

For another example, the memory pool management function may find a most frequently used memory pool from the memory pools 107_1-107_M based on a sorting algorithm. FIG. 4 is a flowchart illustrating a method for finding a most frequently used memory pool according to an embodiment of the present invention. In step 402, the memory pool management function employs a predetermined sorting algorithm to sort the memory pools 107_1-107_M based on used counts of the memory pools 107_1-107_M. In step 404, a list with the memory pools 107_1-107_M sorted in a certain order is created. In step 406, a most frequently used memory pool is decided according to the list of memory pools sorted based on used counts of the memory pools. In a case where the list has the memory pools 107_1-107_M sorted in an ascending order of used counts, the last memory pool in the list is identified as the most frequently used memory pool. In another case where the list has the memory pools 107_1-107_M sorted in a descending order of used counts, the first memory pool in the list is identified as the most frequently used memory pool. In some other embodiments, other methods may be utilized to determine the used frequency of the memory pools 107_1-107_M, which should not be limited in this disclosure.

It is possible that step 206 fails to find any ever-used memory pool available for selection. For example, each memory pool used by previously-executed computing unit(s) is an in-used memory pool of one currently-executed computing unit now. Hence, the memory pool management function searches a not-yet-used memory pool in the memory pools 107_1-107_M, and assigns the not-yet-used memory pool found in the memory pools 107_1-107_M to the computing unit (steps 210 and 212). Since the number of the memory pools 107_1-107_M is not smaller than the number of the computing units CU_1-CU_N and one memory pool can be shared by multiple computing units (i.e., re-used by one or more later-executed computing units), it is ensured that the memory pool management function can find one not-yet-used memory pool from the memory pools 107_1-107_M.

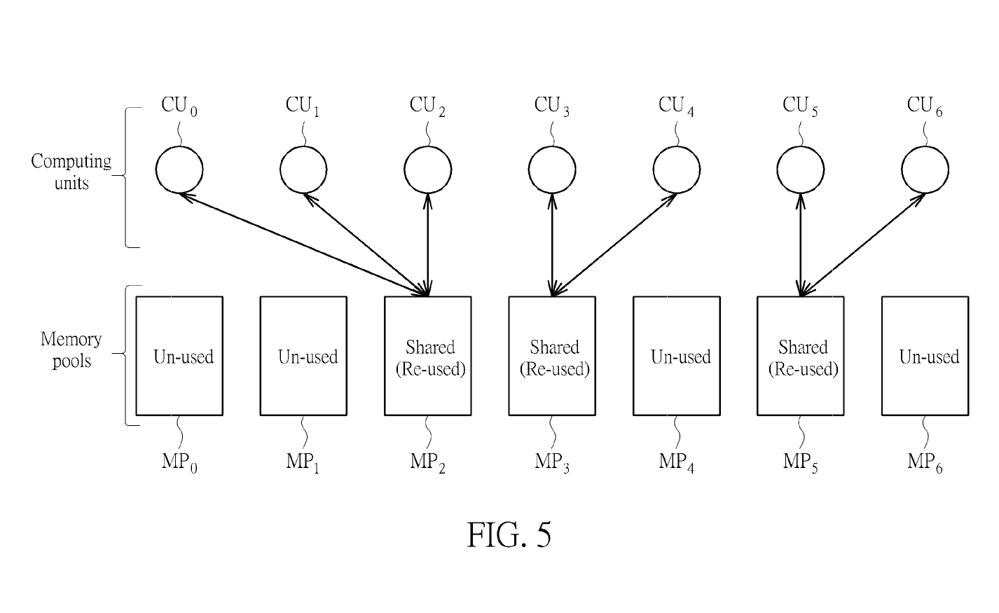

FIG. 5 is a diagram illustrating an example of memory pool management under a condition that the number of memory pools is not smaller than the number of computing units. In this example, the number of memory pools is equal to the number of computing units. As shown in FIG. 5, there are seven computing units (e.g., threads) CU₀-CU₆ and seven memory pools MP₀-MP₆. The memory pool MP₂ is shared by computing units CU₀-CU₂. For example, the memory pool MP₂ is first used by the computing unit CU₀, and then re-used by each of the computing units CU₁ and CU₂, where the computing units CU₀-CU₂ may be executed one by one. The memory pool MP₃ is shared by computing units CU₃ and CU₄. For example, the memory pool MP₃ is first used by the computing unit CU₃, and then re-used by the computing unit CU₄, where the computing units CU₃ and CU₄ may be executed one by one. The memory pool MP₅ is shared by computing units CU₅ and CU₆. For example, the memory pool MP₅ is first used by the computing unit CU₅, and then re-used by the computing unit CU₆, where the computing units CU₅ and CU₆ may be executed one by one. In this example, the same processor completes one process, including seven computing units CU₀-CU₆, by using three memory pools MP2, MP3, and MP5 in all of the allocated memory pools MP₀-MP₆. Hence, the remaining memory pools MP₀, MP₁, MP₄, and MP₆ remain un-used. Compared to assigning one dedicated memory pool to each computing unit, sharing one memory pool among multiple computing units can reduce the cache write miss rate of the cache as well as the bandwidth usage between the cache and the memory device.

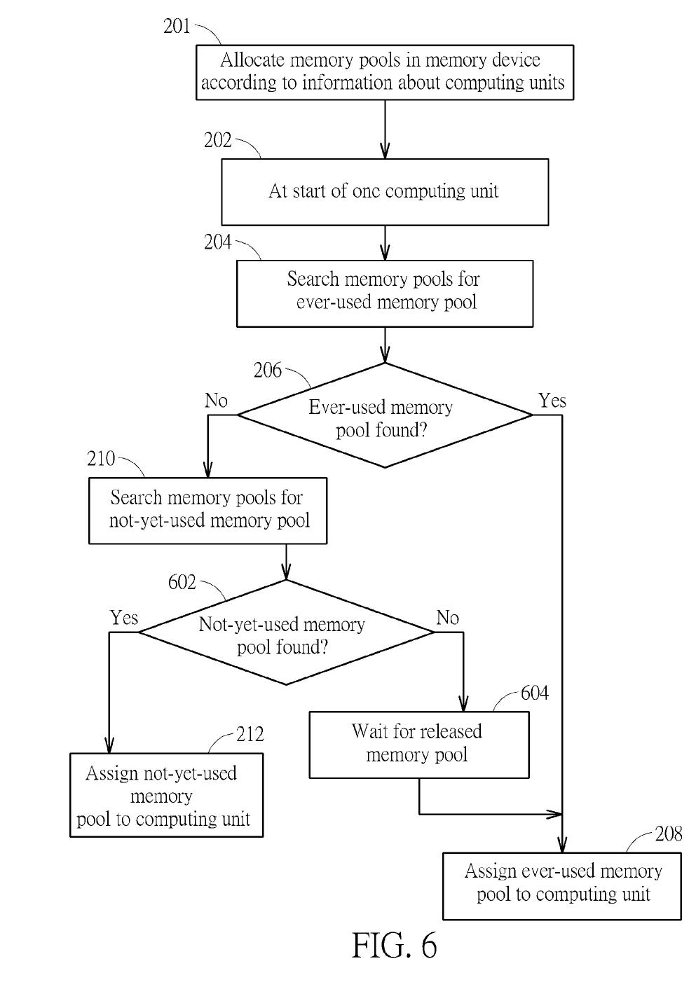

In another case where the number of the memory pools 107_1-107_M is smaller than the number of the computing units CU_1-CU_N (i.e., M<N), the proposed memory pool management may be configured to assign an ever-used memory pool, a not-yet-used memory pool, or a released memory pool to a computing unit. FIG. 6 is a flowchart illustrating a second memory pool management according to an embodiment of the present invention. Provided that the result is substantially the same, the steps are not required to be executed in the exact order shown in FIG. 6. The memory pool management method may be performed by the program code PROG loaded and executed by the processor 102. The major difference between the memory pool management methods in FIG. 6 and FIG. 2 is that the memory pool management method in FIG. 6 further include following steps.

Step 602: Is the not-yet-used memory pool found in the memory pools? If yes, go to step 212; otherwise, go to step 604.

Step 604: Wait for a released memory pool (i.e., an in-used memory pool released to be an ever-used memory pool). When the released memory pool is available, the flow proceeds with step 208.

The memory pool management function supports sharing/reusing one memory pool. After the execution of a computing unit is completed, an in-used memory pool is released and becomes an ever-used memory pool. Since the number of memory pools is smaller than the number of computing units, it is possible that all of the memory pools are in use at the start of one computing unit. Hence, after searching the memory pools 107_1-107_M for an ever-used memory pool is not successful (step 204), searching the memory pools 107_1-107_M for a not-yet-used memory pool may not be successful (step 210). In step 602, the memory pool management function checks if the not-yet-used memory pool can be found in the memory pools 107_1-107_M. When the not-yet-used memory pool can be found in the memory pools 107_1-107_M, the memory pool management function assigns the not-yet-used memory pool to the computing unit (step 212). However, when the not-yet-used memory pool cannot be found in the memory pools 107_1-107_M, the memory pool management function has to wait for a released memory pool (step 604). Because all of the memory pools 107_1-107_M are in use at the start of a current computing unit, none of the in-used memory pools 107_1-107_M can be assigned to the current computing unit. When the execution of one previous computing unit is completed, an associated in-used memory pool is released and then becomes an ever-used memory pool that is selectable. Hence, when a released memory pool is available in the memory device 106, the memory pool management function assigns the released memory pool to the current computing unit (step 208).

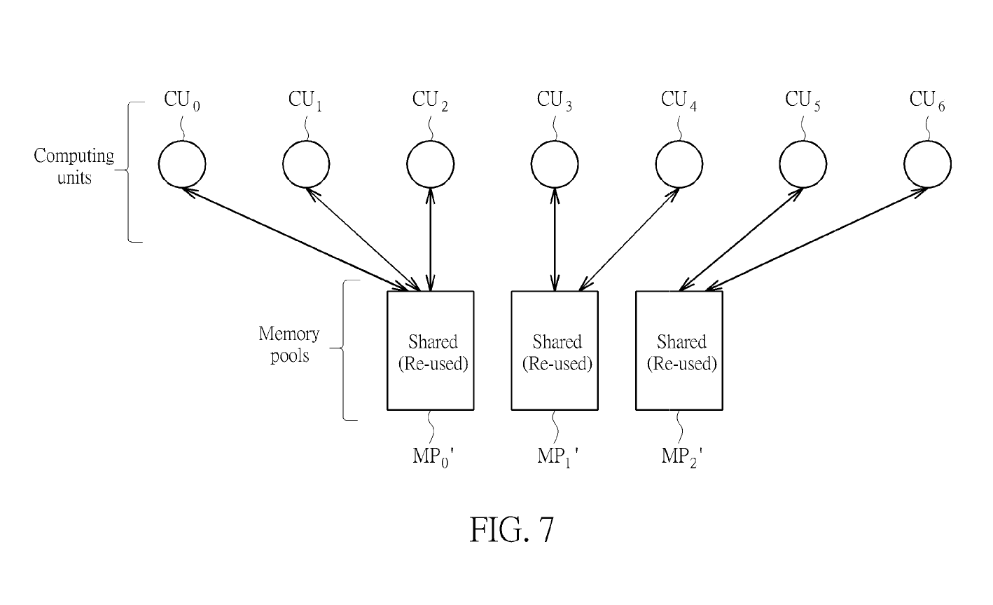

FIG. 7 is a diagram illustrating an example of memory pool management under a condition that the number of memory pools is smaller than the number of computing units. As shown in FIG. 7, there are seven computing units (e.g., threads) CU₀-CU₆ and three memory pools MP₀′-MP₂. The memory pool MP₀′ is shared by computing units CU₀-CU₂. For example, the memory pool MP₀′ is first used by the computing unit CU₀, and then re-used by each of the computing units CU₁ and CU₂, where the computing units CU₀-CU₂ may be executed one by one. The memory pool WY is shared by computing units CU₃ and CU₄. For example, the memory pool MP₁′ is first used by the computing unit CU₃, and then re-used by the computing unit CU₄, where the computing units CU₃ and CU₄ may be executed one by one. The memory pool MP₂′ is shared by computing units CU₅ and CU₆. For example, the memory pool MP₂′ is first used by the computing unit CU₅, and then re-used by the computing unit CU₆, where the computing units CU₅ and CU₆ may be executed one by one. In this example, the same processor can complete one process, including seven computing units CU₀-CU₆, by using only three memory pools MP₀′-MP₂′ allocated in the memory device. Hence, the memory size requirement of the memory device (e.g., DRAM or SRAM) can be relaxed. Further, compared to assigning one dedicated memory pool to each computing unit, sharing one memory pool among multiple computing units can reduce the cache write miss rate of the cache as well as the bandwidth usage between the cache and the memory device.

In aforementioned embodiments, the proposed memory pool management is implemented using a software-based design, such as the program code PROG running on the processor 102. However, this is for illustrative purposes only. In other embodiments, the proposed memory pool management may be implemented using a hardware-based design, such as pure hardware dedicated to performing the memory pool management.

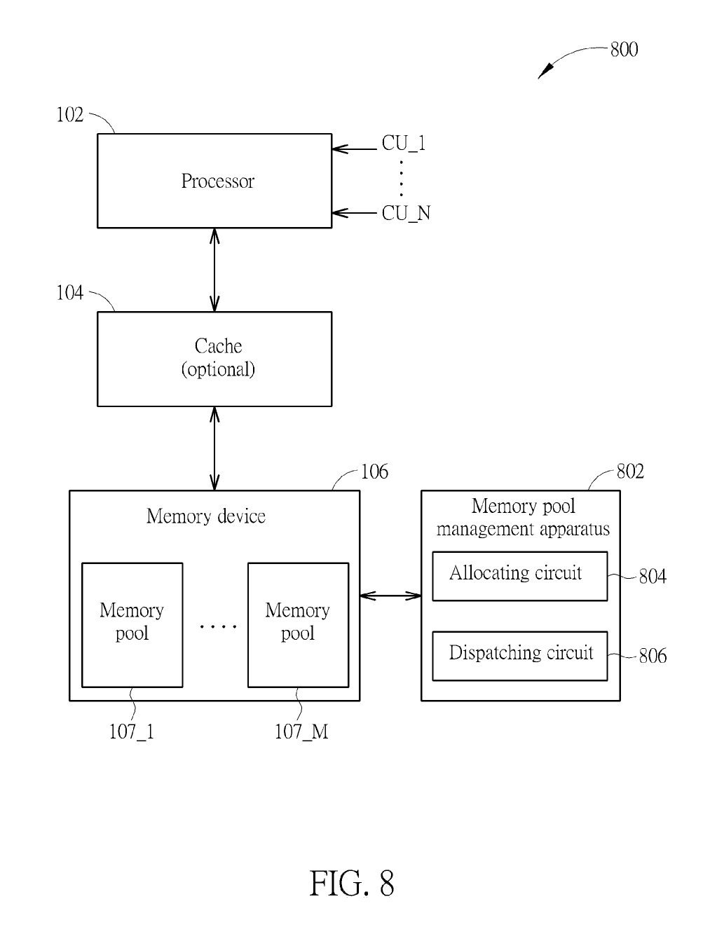

FIG. 8 is a diagram illustrating another computing system according to an embodiment of the present invention. The computing system 800 includes a memory pool management apparatus 802 and the aforementioned processor 102, cache 104 and memory device 106. In this embodiment, the aforementioned program code PROG may be omitted, and the memory pool management apparatus 802 includes an allocating circuit 804 and a dispatching circuit 806. The memory pool management apparatus 802 is memory pool management hardware configured to perform the proposed memory pool management with memory pool sharing/reusing. The allocating circuit 804 is arranged to allocate the memory pools 107_1-107_M in the memory device 106 according to information about the computing units CU_1-CU_M to be executed by the processor 102. The dispatching circuit 806 is arranged to assign one of the memory pools 107_1-107_M to one of the computing units CU_1-CU_M. In one exemplary design, the memory pool management method shown in FIG. 2 may be employed by the memory pool management apparatus 802. For example, step 201 is performed by the allocating circuit 804, and steps 202, 204, 206, 208, 210 and 212 are performed by the dispatching circuit 806. In another exemplary design, the memory pool management method shown in FIG. 6 may be employed by the memory pool management apparatus 802. For example, step 201 is performed by the allocating circuit 804, and steps 202, 204, 206, 208, 210, 212, 602 and 604 are performed by the dispatching circuit 806. As a person skilled in the pertinent art can readily understand details of the hardware-based memory pool management design (e.g., memory pool management performed by allocating circuit 804 and dispatching circuit 806) after reading above paragraphs directed to the software-based memory pool management design (e.g., memory pool management performed by program code PROG running on processor 102), further description is omitted here for brevity.

Those skilled in the art will readily observe that numerous modifications and alterations of the device and method may be made while retaining the teachings of the invention. Accordingly, the above disclosure should be construed as limited only by the metes and bounds of the appended claims.

1. A memory pool management method comprising:
allocating a plurality of memory pools in a memory device according to information about a plurality of computing units, wherein the computing units are independently executed on a same processor; and
assigning one of the memory pools to one of the computing units, wherein at least one of the memory pools is shared among different computing units of the computing units.

2. The memory pool management method of claim 1, wherein a number of the memory pools is not smaller than a number of the computing units.

3. The memory pool management method of claim 2, wherein assigning one of the memory pools to one of the computing units comprises:
at a start of a computing unit of the computing units, searching the memory pools for an ever-used memory pool; and
when the ever-used memory pool is found in the memory pools, assigning the ever-used memory pool to the computing unit.

4. The memory pool management method of claim 3, wherein the ever-used memory pool is a most frequently used memory pool among the memory pools.

5. The memory pool management method of claim 3, wherein assigning one of the memory pools to one of the computing units further comprises:
when the ever-used memory pool is not found in the memory pools, assigning a not-yet-used memory pool in the memory pools to the computing unit.

6. The memory pool management method of claim 1, wherein a number of the memory pools is smaller than a number of the computing units.

7. The memory pool management method of claim 6, wherein assigning one of the memory pools to one of the computing units comprises:
at a start of a computing unit of the computing units, searching the memory pools for an ever-used memory pool; and
when the ever-used memory pool is found in the memory pools, assigning the ever-used memory pool to the computing unit.

8. The memory pool management method of claim 7, wherein the ever-used memory pool is a most frequently used memory pool among the memory pools.

9. The memory pool management method of claim 7, wherein assigning one of the memory pools to one of the computing units further comprises:
when the ever-used memory pool is not found in the memory pools, searching the memory pools for a not-yet-used memory pool; and
when the not-yet-used memory pool is found in the memory pools, assigning the not-yet-used memory pool to the computing unit.

10. The memory pool management method of claim 7, wherein assigning one of the memory pools to one of the computing units further comprises:
when the not-yet-used memory pool is not found in the memory pools, waiting for a released memory pool in the memory pools; and
when the released memory pool is available, assigning the released memory pool to the computing unit.

11. A non-transitory machine readable medium having a program code stored therein, wherein when executed by a processor, the program code instructs the processor to perform following steps:
allocating a plurality of memory pools in a memory device according to information about a plurality of computing units, wherein the computing units are independently executed on the processor; and
assigning one of the memory pools to one of the computing units, wherein at least one of the memory pools is shared among different computing units of the computing units.

12. The non-transitory machine readable medium of claim 11, wherein a number of the memory pools is not smaller than a number of the computing units.

13. The non-transitory machine readable medium of claim 12, wherein assigning one of the memory pools to one of the computing units comprises:
at a start of a computing unit of the computing units, searching the memory pools for an ever-used memory pool; and
when the ever-used memory pool is found in the memory pools, assigning the ever-used memory pool to the computing unit.

14. The non-transitory machine readable medium of claim 13, wherein the ever-used memory pool is a most frequently used memory pool among the memory pools.

15. The non-transitory machine readable medium of claim 13, wherein assigning one of the memory pools to one of the computing units further comprises:
when the ever-used memory pool is not found in the memory pools, assigning a not-yet-used memory pool in the memory pools to the computing unit.

16. The non-transitory machine readable medium of claim 11, wherein a number of the memory pools is smaller than a number of the computing units.

17. The non-transitory machine readable medium of claim 16, wherein assigning one of the memory pools to one of the computing units comprises:
at a start of a computing unit of the computing units, searching the memory pools for an ever-used memory pool; and
when the ever-used memory pool is found in the memory pools, assigning the ever-used memory pool to the computing unit.

18. The non-transitory machine readable medium of claim 17, wherein the ever-used memory pool is a most frequently used memory pool among the memory pools.

19. The non-transitory machine readable medium of claim 17, wherein assigning one of the memory pools to one of the computing units further comprises:
when the ever-used memory pool is not found in the memory pools, searching the memory pools for a not-yet-used memory pool; and
when the not-yet-used memory pool is found in the memory pools, assigning the not-yet-used memory pool to the computing unit.

20. The non-transitory machine readable medium of claim 17, wherein assigning one of the memory pools to one of the computing units further comprises:
when the not-yet-used memory pool is not found in the memory pools, waiting for a released memory pool in the memory pools; and
when the released memory pool is available, assigning the released memory pool to the computing unit.

21. A memory pool management apparatus comprising:
an allocating circuit, arranged to allocate a plurality of memory pools in a memory device according to information about a plurality of computing units, wherein the computing units are independently executed on a same processor; and
a dispatching circuit, arranged to assign one of the memory pools to one of the computing units, wherein at least one of the memory pools is shared among different computing units of the computing units.

22. The memory pool management apparatus of claim 21, wherein a number of the memory pools is not smaller than a number of the computing units.

23. The memory pool management apparatus of claim 22, wherein at a start of a computing unit of the computing units, the dispatching circuit is arranged to search the memory pools for an ever-used memory pool; and when the ever-used memory pool is found in the memory pools, the dispatching circuit is arranged to assign the ever-used memory pool to the computing unit.

24. The memory pool management apparatus of claim 23, wherein the ever-used memory pool is a most frequently used memory pool among the memory pools.

25. The memory pool management apparatus of claim 23, wherein when the ever-used memory pool is not found in the memory pools, the dispatching circuit is arranged to assign a not-yet-used memory pool in the memory pools to the computing unit.

26. The memory pool management apparatus of claim 21, wherein a number of the memory pools is smaller than a number of the computing units.

27. The memory pool management apparatus of claim 26, wherein at a start of a computing unit of the computing units, the dispatching circuit is arranged to search the memory pools for an ever-used memory pool; and when the ever-used memory pool is found in the memory pools, the dispatching circuit is arranged to assign the ever-used memory pool to the computing unit.

28. The memory pool management apparatus of claim 27, wherein the ever-used memory pool is a most frequently used memory pool among the memory pools.

29. The memory pool management apparatus of claim 27, wherein when the ever-used memory pool is not found in the memory pools, the dispatching circuit is arranged to search the memory pools for a not-yet-used memory pool; and when the not-yet-used memory pool is found in the memory pools, the dispatching circuit is arranged to assign the not-yet-used memory pool to the computing unit.

30. The memory pool management apparatus of claim 27, wherein when the not-yet-used memory pool is not found in the memory pools, the dispatching circuit is arranged to wait for a released memory pool in the memory pools; and when the released memory pool is available, the dispatching circuit is arranged to assign the released memory pool to the computing unit.
